(19) United States
(12) Patent Application Publication
(10) Pub. No.: US 2024/0346790 A1
(43) Pub. Date: Oct. 17, 2024

(54) 3D DATA AUGMENTATION METHOD USING WEIGHTED LOCAL TRANSFORMATION AND APPARATUS THEREFOR

(71) Applicant: Korea University Research and Business Foundation, Seoul (KR)

(72) Inventors: Hyunwoo KIM, Yongin-si (KR); Sihyeon KIM, Seoul (KR); Jin-Young PARK, Seoul (KR); Sang Hyeok LEE, Seoul (KR)

(21) Appl. No.: 18/634,813

(22) Filed: Apr. 12, 2024

(30) Foreign Application Priority Data
Apr. 14, 2023 (KR) 10-2023-0049562

(51) Int. Cl. G06T 19/20; G06T 5/70; G06T 7/11

(52) U.S. Cl. CPC G06T 19/20; G06T 5/70; G06T 7/11; G06T 2219/2016

(57) ABSTRACT

The present disclosure relates to a three-dimensional (3D) data augmentation method using a weighted local transformation and an apparatus for the same. More specifically, the present disclosure relates to a method and apparatus of significantly augmenting 3D data required to improve the performance of an artificial intelligence model with only limited 3D data by applying a non-rigid transformation to local part(s) of the 3D data.

### CROSS-REFERENCE TO RELATED APPLICATION

The present application claims the benefit of priority to Korean Patent Application No. 10-2023-0049562, filed on Apr. 14, 2023, in the Korean Intellectual Property Office, the entire contents of which is incorporated herein for all purposes by this reference.

### BACKGROUND OF THE INVENTION

### Field of the Invention

The present disclosure relates to a three-dimensional (3D) data augmentation method using a weighted local transformation and an apparatus for the same. More specifically, the present disclosure relates to a method and apparatus of significantly augmenting 3D data required to improve the performance of an artificial intelligence model with only limited 3D data by applying a non-rigid transformation based on kernel regression to local part(s) of the 3D data.

### Background of the Related Art

Artificial intelligence (AI) and deep learning algorithms are widely used in the field of computer vision, and in particular, actively utilized in detecting and tracking an object or a person in a scene and an image, and measuring symmetry and horizontality.

Meanwhile, these artificial intelligence algorithms require learning to improve their performance, and an amount of learning data referenced for this learning has a significant influence on the learning effect of artificial intelligence, and furthermore, the performance of the artificial intelligence algorithm.

However, in the case of 3D data, basically a size of the data is not small, but significant resources are required to process the data, so it is not easy to secure 3D data for the training of the artificial intelligence algorithms.

The present disclosure is proposed to solve the foregoing problems in the related art, and relates to a method and apparatus of executing a transformation on local parts of given 3D data to easily secure 3D data having various shapes.

### CITATION LIST

### Patent Literature

Korean Patent Registration No. 10-2225822 (published on Mar. 10, 2021)

### SUMMARY OF THE INVENTION

A technical problem to be solved by the present disclosure is to provide a method and apparatus of executing a transformation with respect to local parts from given 3D data to augment the 3D data.

Another technical problem to be solved by the present disclosure is to provide a method and apparatus of preventing significant heterogeneity in new 3D data acquired from original 3D data by executing a non-rigid transformation.

Technical problems of the present disclosure are not limited to the above-mentioned problems, and other technical problems which are not mentioned herein will be clearly understood by those skilled in the art from the description below.

In order to solve the foregoing technical problems, a method of augmenting, by an apparatus including a processor and a memory, three-dimensional (3D) data through a local transformation may include (a) a data processing step of receiving original 3D data and anchor point number information, and acquiring a number of sampled anchor points corresponding to 3D data subsequent to processing and the anchor point number information based on the original 3D data and anchor point number information; (b) a transformation parameter sampling step of receiving at least one transformation parameter and transformation parameter category, and acquiring sampled transformation parameters and transformation parameter values from the transformation parameter and transformation parameter category; and (c) a data augmentation step of calculating a non-rigid transformation matrix based on the 3D data subsequent to processing, sampled anchor points, and sampled transformation parameter values, and acquiring 3D data transformed by using the non-rigid transformation matrix.

Furthermore, in the 3D data augmentation method, the step (a) may include a step (a-1) of performing preprocessing on the original 3D data; and a step (a-2) of sampling a plurality of anchor points that serve as local transformation references on the original 3D data or 3D data subsequent to processing.

Furthermore, in the 3D data augmentation method, the step (a-1) may be performing at least one preprocessing of vertex sampling, centralization, or denoising on the original 3D data.

Furthermore, in the 3D data augmentation method, the step (a-2) may include sampling a first arbitrary anchor point on the original 3D data or 3D data subsequent to processing; and sampling a second anchor point that is present at a position farthest away from the first anchor point on the original 3D data or 3D data subsequent to processing.

Furthermore, in the 3D data augmentation method, the step (a) may be further receiving scene data, wherein the step (a-2) includes sampling a plurality of anchor points targeting the scene data, the step (a-2) further including segmenting a plurality of instances in the scene data; and sampling one or more anchor points on at least one instance from among the plurality of segmented instances.

Furthermore, in the 3D data augmentation method, the transformation parameter may include at least one of rotation transformation, scaling, and translation.

Furthermore, in the 3D data augmentation method, the sampled transformation parameter values may be random values extracted from within the transformation parameter category. Furthermore, in the 3D data augmentation method, the step (c) may include a step (c-1) of applying transformation parameters extracted from N anchor points to calculate N local transformation matrices; a step (c-2) of linearly combining the N local transformation matrices to acquire a non-rigid transformation matrix; and a step (c-3) of applying the non-rigid transformation matrix to the 3D data subsequent to processing to acquire transformed 3D data.

On the other hand, a 3D data augmentation apparatus according to another embodiment of the present disclosure may include one or more processors; a network interface; a memory that loads a computer program executed by the processor; and a storage that stores large-capacity network data and the computer program, wherein the computer program executes, by the one or more processors, a first operation of receiving original 3D data and anchor point number information, and acquiring a number of sampled and the anchor point number information based on the original 3D data and anchor point number information; a second operation of receiving at least one transformation parameter and transformation parameter category, and acquiring sample transformation parameter values sampled from the transformation parameter and transformation parameter category; and a third operation of calculating a non-rigid transformation matrix based on the 3D data subsequent to processing, sampled anchor points, and sample transformation parameter values, and acquiring 3D data transformed by using the non-rigid transformation matrix.

A computer program stored on a computer-readable medium according to still another embodiment of the present disclosure may execute, in connection with a computing apparatus, (a) a data processing step of receiving original 3D data and anchor point number information, and acquiring a number of sampled anchor points corresponding to 3D data subsequent to processing and the anchor point number information based on the original 3D data and anchor point number information; (b) a transformation parameter sampling step of receiving at least one transformation parameter and transformation parameter category, and acquiring sample transformation parameter values sampled from the transformation parameter and transformation parameter category; and (c) a data augmentation step of calculating a non-rigid transformation matrix based on the 3D data subsequent to processing, sampled anchor points, and sample transformation parameter values, and acquiring 3D data transformed by using the non-rigid transformation matrix.

According to the present disclosure as described above, there is an effect capable of naturally augmenting various 3D data through a local transformation.

Furthermore, the method may be applicable to any 3D data, and thus may have high versatility so as to generate a large amount of diverse 3D data.

In addition, according to the present disclosure, there is an effect capable of easily and quickly augmenting data with relatively few resources for 3D data that is not easy to process.

The effects of the present disclosure are not limited to the above-mentioned effects, and other effects that are not mentioned herein will be clearly understood by those skilled in the art from the description below.

### BRIEF DESCRIPTION OF THE DRAWINGS

FIG. 1 is a diagram illustratively showing an overall configuration of an augmentation apparatus that performs a local transformation to augment 3D data according to the present disclosure.

FIG. 2 is a view showing a local transformation process for actual 3D data in order to assist the understanding of a 3D data augmentation method according to the present disclosure.

FIG. 3 is a flowchart showing a 3D data augmentation method according to the present disclosure in an order thereof.

FIG. 4 is a diagram for easily understanding which information is input to especially a data processing unit 1000 in the configuration of the augmentation apparatus 100 and which information is output therefrom.

FIG. 5 is a view showing an image in which a plurality of anchor points are sampled.

FIG. 6 is a view showing an image of preprocessing and anchor point sampling for scene data.

FIG. 7 is a diagram for easily understanding which information is input to and output from a transformation parameter sampling unit 2000, and FIG. 8 shows a specific example thereof.

FIG. 9 is a diagram showing a process of calculating 3D data transformed by a data augmentation unit 3000.

### DETAILED DESCRIPTION OF THE PREFERRED EMBODIMENT

The details of the objects and technical configurations of the present disclosure and operational effects thereof will be more clearly understood from the following detailed description based on the accompanying drawings appended hereto. Hereinafter, embodiments according to the present disclosure will be described in detail with reference to the accompanying drawings.

Embodiments disclosed herein should not be interpreted as limiting or used to limit the scope of the present disclosure. It is apparent for those skilled in the art that a description including embodiments herein has various applications. Therefore, any embodiments described in the detailed description of the present disclosure are illustrative for better understanding of the present disclosure and are not intended to limit the scope of the present disclosure to the embodiments.

Functional blocks illustrated in the drawings and described hereunder are only examples of possible implementations. In other implementations, other functional blocks may be used without departing from the concept and scope of the detailed description. Furthermore, one or more functional blocks of the present disclosure are illustrated as separate blocks, but one or more of the functional blocks of the present disclosure may be a combination of various hardware and software elements that execute the same function.

In addition, an expression that some elements are “included” is an expression of an “open type”, and the expression simply denotes that the corresponding elements are present, but should not be construed as excluding additional elements.

Moreover, in case where it is mentioned that one element is “connected” or “coupled” to the other element, it should be understood that one element may be directly connected to the other element, but another element may be present therebetween.

Hereinafter, detailed embodiments of the present disclosure will be described with reference to the drawings.

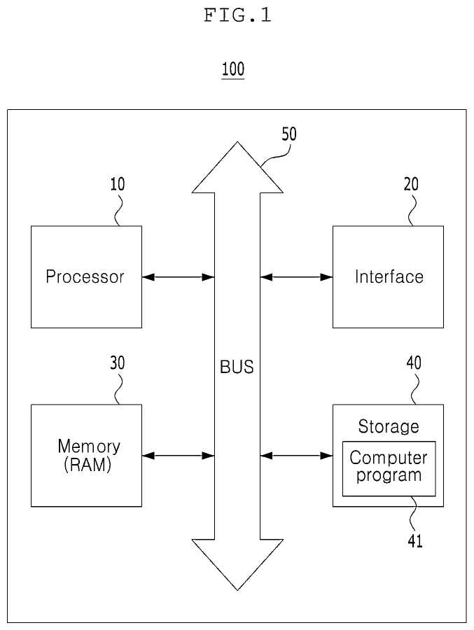

FIG. 1 is a diagram illustratively showing an overall configuration of an augmentation apparatus 100 that performs a local transformation to augment 3D data according to the present disclosure. For reference, in this detailed description, it is to be understood that the term “augmentation apparatus 100” is used instead of “apparatus 100” in order to distinguish the terms and assist the understanding of the disclosure.

In addition, the illustration in FIG. 1 is only a preferred embodiment for achieving the objectives of the present disclosure, and some components may be added thereto or deleted therefrom as needed, and a function performed by any one component may, of course, be performed together with other components.

The augmentation apparatus 100 according to a first embodiment of the present disclosure may include a processor 10, a network interface 20, a memory 30, a storage 40, and a data bus 50 connecting therebetween, and may, of course, further include additional components required to achieve the other objectives of the present disclosure.

The processor 10 controls an overall operation of each component. The processor 10 may be any one of a central processing unit (CPU), a microprocessor unit (MPU), a micro controller unit (MCU), or a type of processor widely known in the art to which the present disclosure pertains.

Moreover, the processor 10 may perform calculations on at least one application or program for performing a 3D data augmentation method according to the present disclosure, which may be an artificial intelligence processor implemented with an artificial intelligence model based on various network models.

The network interface 20 may support wired and wireless Internet communication of the augmentation apparatus 100 according to the present disclosure, and may also support other known communication methods. Therefore, the network interface 20 may include a communication module according thereto.

The memory 30 may store various types of data, commands, and/or information, and load one or more computer programs 41 from the storage 40 in order to perform the 3D data augmentation method according to the present disclosure. Although a RAM is shown as a type of the memory 30 in FIG. 1, various storage media may, of course, be used for the memory 30 in addition thereto.

The storage 40 may non-temporarily store one or more computer programs 41 and mass network information 42. The storage 40 may be any one of a non-volatile memory such as a read only memory (ROM), an erasable programmable ROM (EPROM), an electrically erasable programmable ROM (EEPROM), a flash memory, or the like, a hard disk, a removable disk, and a type of computer-readable recording medium widely known in the art to which the present disclosure pertains.

The computer program 41 may be loaded into the memory 30 to execute, by one or more processors 10, (a) a first operation of 3D data and anchor point number information, and receiving acquiring a number of sampled anchor points corresponding to 3D data subsequent to processing and the anchor point number information based on the 3D data and anchor point number information; (b) a second operation of receiving at least one parameter and a parameter category, and acquiring sample parameter values sampled from the parameter and parameter category; and (c) a third operation of calculating a non-rigid transformation matrix based on the 3D data subsequent to processing, sampled anchor points, and sample parameter values, and acquiring 3D data transformed by using the non-rigid transformation matrix.

The operation performed by the computer program 41 briefly mentioned above may be regarded as a function of the computer program 41, and a more detailed description thereof will be described later in the detailed description below.

The data bus 50 serves as a transfer path for commands and/or information among the processor 10, the network interface 20, the memory 30, and the storage 40 described above.

In the present disclosure described above, the augmentation apparatus 100 may be in the form of an independent device, for example, an electronic apparatus or a server (including a cloud), and in the latter case, may be downloaded and installed on a user terminal in the form of a dedicated application.

Moreover, herein, the electronic apparatus may be a portable apparatus such as a smartphone, a tablet PC, a laptop PC, a PDA, a PMP, or the like, as well as a desktop PC that is fixedly installed and used in one place, and any electronic apparatus may also be used as long as it has a network function.

Hereinafter, a method of augmenting 3D data will be described with reference to the drawings on the assumption that the augmentation apparatus 100 according to the present disclosure is a server in the form of an independent device.

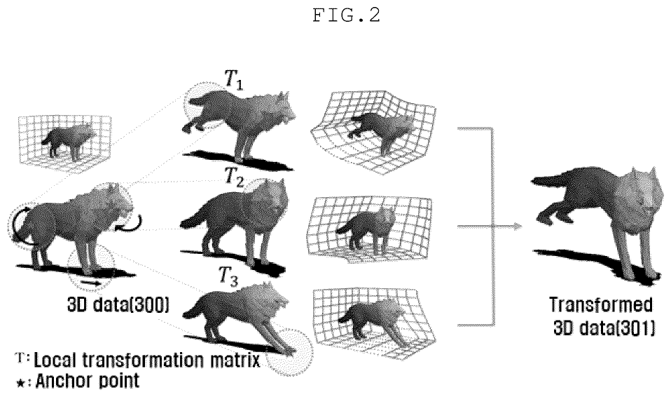

FIG. 2 is to assist the understanding of the 3D data augmentation method according to the present disclosure, which shows a process of executing, when original 3D data 300 is present in the shape of a wolf, a local transformation thereon so as to obtain its resultant transformed 3D data 301.

Referring to the drawings, the 3D data augmentation method according to the present disclosure may basically set a predetermined number of anchor points on the 3D data 300, and execute a local transformation with respect to the anchor points, thereby obtaining the transformed 3D data 301 in various forms.

Specifically, it can be seen that anchor points are set for a tail, a head, and a forefoot, respectively, on the original 3D data 300, can be confirmed that a transformation is executed by a first local transformation matrix T1, a second local transformation matrix T2, and a third local transformation matrix T3 with respect to the anchor points, respectively, so that the shapes of the tail, head, and forefoot parts are transformed, respectively, and furthermore, it can be seen that the shapes are linearly combined and finally output in the form of the transformed 3D data 301.

As such, the 3D data augmentation method according to the present disclosure may set at least one anchor point on given 3D data, and execute a local transformation with respect to the anchor point(s) so as to obtain 3D data of a transformed shape.

With reference to FIG. 2, a technical overview of the 3D data augmentation method according to the present disclosure has been described.

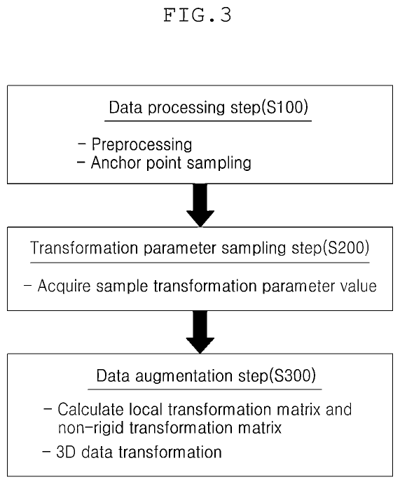

FIG. 3 is a flowchart showing a process of progressing the 3D data augmentation method in an order thereof. Referring to the drawing, the 3D data augmentation method may broadly include a data processing step S100, a parameter sampling step S200, a transformation parameter sampling step S200, and a data augmentation step S300.

The data processing step S100 is a first step that is firstly executed in an entire process of the 3D data augmentation method, and in this step, a process of receiving original 3D data and then preprocessing the received 3D data, and a process of sampling a predetermined number of anchor points on the 3D data may be carried out.

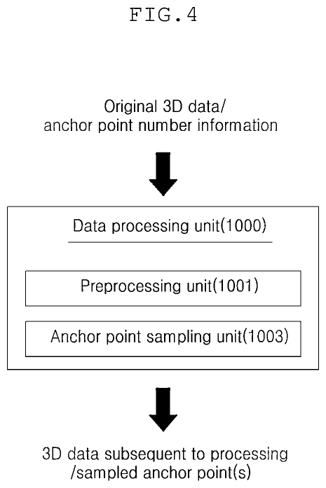

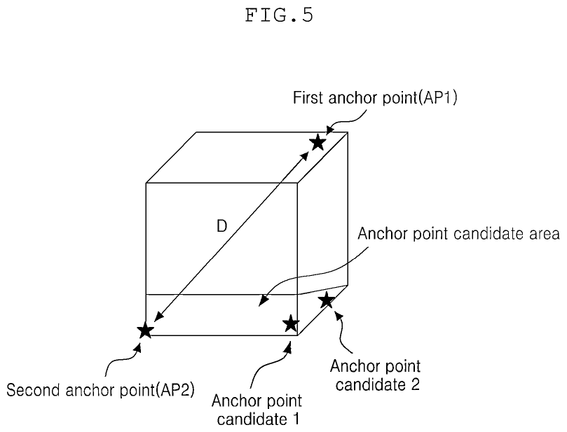

FIG. 4 is a diagram for more easily understanding the data processing step S100, wherein it is shown in FIG. 4 which information is input to the data processing unit 1000 among the components implemented in the augmentation apparatus 100 and which information is output therefrom. Specifically, the data processing unit 1000 may receive original 3D data and anchor point number information as an input thereto. The meaning of ‘receiving,’ by the data processing unit 1000, the foregoing data and information may include various implementation examples, and for example, there may be included an example of manipulating an input means (keyboard, mouse, etc.) connected to the augmentation apparatus 100 to directly load, by a user, original 3D data into a program or enter anchor point number information, or an implementation example of receiving original 3D data or receiving anchor point number information from an external terminal (e.g. smartphone terminal) connected to the augmentation apparatus 100 through a network, or the like, in the implementation example of receiving by the data processing unit 1000, strictly speaking, the augmentation apparatus 100.

The original 3D data received by the data processing unit 1000 as an input thereto may comprehensively refer to data that can represent various types of 3D shapes, such as 3D voxels, 3D meshes, or 3D point clouds. For reference, this detailed description will be described on the assumption that the original 3D data is 3D point clouds to aid the understanding of the disclosure.

Various types of input 3D data (original 3D data) may be preprocessed by a preprocessor 1001 to be transformed into a form that facilitates later transformation, and the types of preprocessing may include, for example, point or vertex sampling, centralization, or denoising. The preprocessed original 3D data will be referred to as ‘3D data subsequent to processing’ in this detailed description.

Meanwhile, the anchor point number information received by the data processing unit 1001 as an input thereto literally means information on a number of anchor points required for a local transformation. The anchor point number information may be entered as a number according to the user's intention, or in some cases, the user may be allowed to input the anchor point number information as a range rather than a set number. For example, the user may input the number of anchor points as 3 to 5 to allow the data processing unit 1001 to autonomously determine the number of anchor points required for transformation. In addition, even if there is no input of anchor point number information, the data processing unit 1001 may be implemented to independently determine the number of anchor points by taking into account a structural feature, a size of shape, and the like that can be derived from the original 3D data. As a simple example, if the original 3D data is identified as including three parts accounting for more than 20% of the volume of an entire structure, then the data processing unit 1001 may be implemented to determine that it is appropriate to set one anchor point for each part such that the anchor point number information can be settled to be three.

Meanwhile, subsequent to receiving or determining the anchor point number information, the anchor point sampling unit 1003 in the data processing unit 1000 may sample a plurality of anchor points that serve as references for local transformations. Simply put, the anchor point sampling unit 1003 may determine a previously determined number of anchor points on 3D data, and at this time, the target 3D data may be original 3D data prior to preprocessing or preprocessed 3D data subsequent to processing. In other words, the anchor point sampling process may be carried out on 3D data regardless of whether preprocessing is performed.

FIG. 5 is a view showing an image in which anchor points are sampled in an easy-to-understand manner. The anchor point sampling process first includes sampling and determining a first arbitrary anchor point AP1 on 3D data. Since the first anchor point AP1 is arbitrarily determined, the location may be one of various places, and understandably, the location of the first anchor point AP1 is determined on 3D data. Meanwhile, subsequent to determining the first anchor point AP1, a second anchor point AP2 may be sampled. There are no special conditions or restrictions when sampling the second anchor point AP2, but preferably, a point that is present at a position farthest away from the first anchor point AP1 or at a position farther away from the first anchor point AP1 by a distance greater than a preset value may be sampled as the second anchor point AP2 for implementation. This is to prevent local transformations from being carried out at positions that are too close to each other on 3D data, and when local transformations and linear combinations are performed simultaneously at two anchor points that are too close to each other, finally calculated 3D data subsequent to transformation may have an unnatural shape, and furthermore, when sampling subsequent anchor points at such a long distance, local transformations may be performed throughout the shape of the 3D data, and various transformations can be made accordingly. In other words, this means that the coverage of sampled anchor points may be maximized to achieve various shape transformations therethrough. For reference, in the drawing, only the process of sampling the second anchor point AP2 is shown, but it is to be understood that the methodology described above may also be used in the process of sampling subsequent anchor points.

Meanwhile, in the process of sampling anchor points, a user interface may be provided to reflect the user's intention, that is, to perform the sampling of some anchor points through the user's manipulation. In the original embodiment, the anchor point sampling process mentioned in this detailed description is performed automatically without any user input, but in some cases, a user interface may be provided to allow the user to directly determine the anchor points. For example, in FIG. 5, an anchor point candidate area (an area under a solid line shown on a surface of a cube) may be indicated on 3D data, and the user may select an arbitrary position from the above anchor point candidate area to specify an anchor point. Alternatively, it may be implemented such that anchor point candidates may be indicated on the user interface as shown in the drawing to allow the user to select and determine anchor points. The user interface that allows anchor points to be directly specified may be particularly useful in a case where transformation is required to focus on a specific part intended by the user when augmenting 3D data.

On the other hand, in the previous description, it is mentioned that the augmentation apparatus 100 or the data processing unit 1001 receives original 3D data and anchor point number information as an input thereto, but the augmentation apparatus 100 or the data processing unit 1001 may also receive scene data in addition to the above data and information. The scene data may be understood as data including a plurality of identifiable instances therein, and may be two-dimensional or three-dimensional type data. The data processing unit 1001 may also perform preprocessing and anchor point sampling on such scene data. However, in this case, since the scene data includes a plurality of identifiable instances, the data processing unit 1001 may first further perform segmenting and identifying each instance.

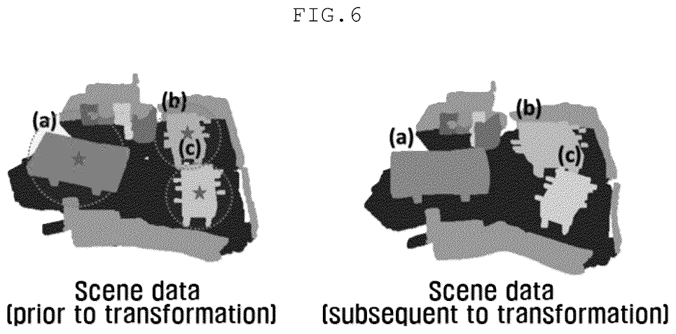

FIG. 6 is a diagram for explaining the execution of instance segmentation and anchor point sampling for scene data, wherein a left side of FIG. 6 shows an image of scene data prior to transformation, and a right side thereof shows an image of scene data subsequent to transformation. Among these, referring to the drawing on the left, as mentioned above, there may be several identifiable instances in the scene data, and these instances may be segmented and identified by using pre-trained semantic segmentation or instance segmentation deep learning models. In FIG. 6, it can be seen that several segmented and identified instances are shown in different colors, and in this detailed description, for convenience of explanation, a description will be continued using instance (a), instance (b), and instance (c) as reference instances. When the instances (a), (b), and (c) are segmented and identified as described above, the data processing unit 1001 may refer to the presence of respective instances when sampling anchor points for the scene data. In other words, the data processing unit 1001 may sample anchor points at specific positions for at least some of the respective instances. Anchor point sampling may be performed such that one anchor point is set per instance, or a number of anchor points below a predetermined ratio value may be set compared to a number of identified instances, or may be performed such that when an arbitrary first anchor point is determined, a subsequent anchor point is set to at least one of instances that are a predetermined distance or more away from the first anchor point. For reference, the left side of FIG. 6 shows an image in which anchor points are sampled for the instances (a), (b), and (c), respectively, and the right side thereof shows an image in which a changed shape is calculated subsequent to performing local transformations around respective anchor points.

In the above, the data processing step S100 in the data processing unit 1001 has been described with reference to FIGS. 3 to 6.

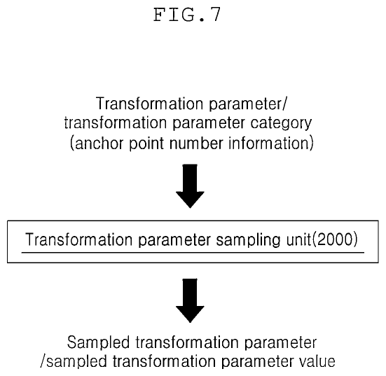

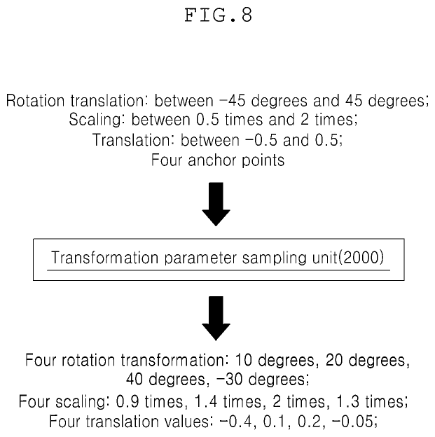

FIG. 7 is a diagram for more easily understanding the transformation parameter sampling step S200, wherein FIG. 7 shows an image in which the transformation parameter sampling unit 2000 among the components implemented in the augmentation apparatus 100 receives transformation transformation parameter parameters, categories, and, if necessary, anchor point number information as an input thereto, and outputs the sampled transformation parameters and sampled transformation parameter values through sampling.

The transformation parameter refers to a parameter required to perform a local transformation, more precisely, a local affine transformation, on 3D data, wherein the type of transformation parameter includes, for example, at least one of rotation transformation, scaling, or translation. The foregoing types are merely examples to assist the understanding of the disclosure, and any parameter that can transform 3D data may be included in one type of transformation parameter. The transformation parameter category refers to a range that can be executed according to each transformation parameter, and for example, an angle range that can be transformed in the case of rotation transformation, a multiple range in the case of scaling, and a distance range in the case of translation.

If necessary, the anchor point number information may be input to the transformation parameter sampling unit 2000, but if the data processing unit 1000 and the transformation parameter sampling unit 2000 described above are interoperable with each other, then anchor point number information received or determined by the data processing unit 1000 may be shared with the transformation parameter sampling unit 2000.

Subsequent to receiving the transformation parameters and transformation parameter categories, sampling is performed, wherein the sampling refers to a process of randomly sampling N of respective transformation parameters to be applied within previously received several transformation parameters and a range of transformation parameters. During sampling, normal distribution, uniform distribution, or the like may be used, and data output from the sampling will be transformation parameters and transformation parameter values to be applied to the 3D data (referred to as sampled transformation parameters and sampled transformation parameter values).

In FIG. 8, for each of the transformation parameters such as rotation transformation, scaling, and translation, it is shown an image in which categories between-45 degrees and 45 degrees, between 0.5 times and 2 times, and between −0.5 and 0.5 are input to the transformation parameter sampling unit 2000, and furthermore, information indicating a number of anchor points, which is 4, is input thereto. In this case, subsequent to performing sampling, it can be confirmed that four rotation transformation values (10 degrees, 20 degrees, 40 degrees, −30 degrees), four scaling values (0.9 times, 1.4 times, 2 times, 1.3 times), and four translation values (−0.4, 0.1, 0.2, −0.05) are calculated. In this manner, in the transformation parameter sampling step S200 performed by the transformation parameter sampling unit 2000, transformation parameters and transformation parameter values sampled from the transformation parameters and transformation parameter categories may be acquired.

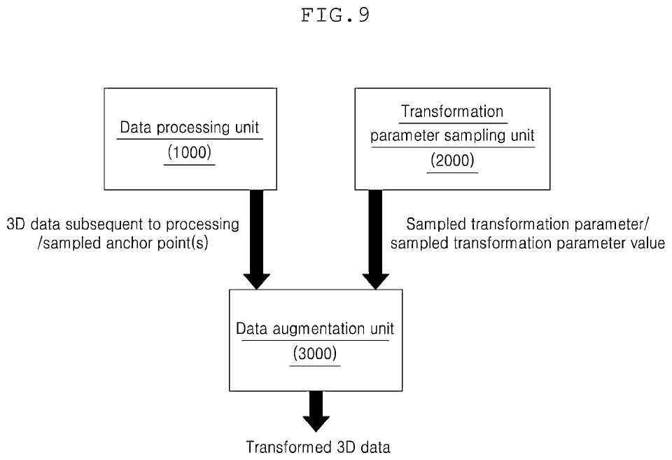

FIG. 9 is a diagram for more easily understanding the data augmentation step S300, wherein it is shown in FIG. 9 that the data augmentation unit 3000 receives [3D data subsequent to processing/sampled anchor point(s)], [sampled transformation parameter(s) and transformation parameter value(s)], and performs a series of matrix operations based thereon to output 3D data that has been transformed.

Further describing the data augmentation step again in more detail, the data augmentation step may include (i) applying transformation parameters extracted from N anchor points to calculate N local transformation matrices, (ii) linearly combining the N local transformation matrices to acquire a non-rigid transformation matrix, and (iii) applying the non-rigid transformation matrix to the 3D data subsequent to processing to acquire transformed 3D data. For reference, N is a letter indicating a number of anchor points.

The calculating of N local transformation matrices may be the applying of transformation parameters extracted from N anchor points to calculate N local transformation matrices, preferably N local affine transformation matrices.

The acquiring of a non-rigid transformation matrix is the acquiring of a non-rigid transformation matrix by performing weighted linearly combination on the N local transformation matrices using kernel regression when the N local transformation matrices are present. In the acquiring of a non-rigid transformation matrix, [Equation 1] below may be used.

$$\hat{T} ( {p}_{i} ) = \frac{{\sum }_{j = 1}^{M} {K}_{h} ( {p}_{i} , {p}_{j}^{𝒜} ) {T}_{j}}{{\sum }_{k = 1}^{M} {K}_{h} ( {p}_{i} , {p}_{k}^{𝒜} )} \qquad [ Equation 1 ]$$

(Tⱼ is a local transformation matrix, Kₕ is a kernel function with a bandwidth h, pᵢ is an arbitrary point included in 3D data, and pⱼ^{A} is an anchor point)

Lastly, the acquiring of the transformed 3D data may be the applying of the previously acquired non-rigid transformation matrix to the 3D data subsequent to processing to obtain the transformed 3D data as an output therefrom.

In the above, the 3D data augmentation method according to the present disclosure and the augmentation apparatus for the same have been described with reference to the above drawings. As described above, the embodiments of the present disclosure have been described with reference to the accompanying drawings, but it will be apparent to those skilled in the art to which the invention pertains that the invention can be embodied in other specific forms without departing from the concept and essential characteristics thereof. Therefore, it should be understood that the foregoing embodiments are merely illustrative but not restrictive in all aspects.

### DESCRIPTION OF SYMBOLS

10: Processor
20: Network interface
30: Memory
40: Storage
41: Computer program
50: Information bus
100: Augmentation apparatus
1000: Data processing unit
1001: Preprocessing unit
1003: Anchor point sampling unit
2000: Transformation parameter sampling unit
3000: Data augmentation unit

What is claimed is:

1. A method of augmenting, by an apparatus comprising a processor and a memory, three-dimensional (3D) data through a local transformation, the method comprising:
(a) a data processing step of receiving original 3D data and anchor point number information, and acquiring a number of sampled anchor points corresponding to 3D data subsequent to processing and the anchor point number information based on the original 3D data and anchor point number information;
(b) a transformation parameter sampling step of receiving at least one transformation parameter and transformation parameter category, and acquiring sampled transformation parameters and transformation parameter values from the transformation parameter and transformation parameter category; and
(c) a data augmentation step of calculating a non-rigid transformation matrix based on the 3D data subsequent to processing, sampled anchor points, and sampled transformation parameter values, and acquiring 3D data transformed by using the non-rigid transformation matrix.

2. The method of claim 1, wherein the step (a) comprises:
a step (a-1) of performing preprocessing on the original 3D data; and
a step (a-2) of sampling a plurality of anchor points that serve as local transformation references on the original 3D data or 3D data subsequent to processing.

3. The method of claim 2, wherein the step (a-1) is performing at least one preprocessing of vertex sampling, centralization, or denoising on the original 3D data.

4. The method of claim 2, wherein the step (a-2) comprises:
sampling a first arbitrary anchor point on the original 3D data or 3D data subsequent to processing; and
sampling a second anchor point that is present at a position farthest away from the first anchor point on the original 3D data or 3D data subsequent to processing.

5. The method of claim 2, wherein the step (a) is further receiving scene data,
wherein the step (a-2) comprises sampling a plurality of anchor points targeting the scene data, the step (a-2) further comprising:
segmenting a plurality of instances in the scene data; and
sampling one or more anchor points on at least one instance from among the plurality of segmented instances.

6. The method of claim 1, wherein the transformation parameter comprises at least one of rotation transformation, scaling, and translation.

7. The method of claim 6, wherein the sampled transformation parameter values are random values extracted from within the transformation parameter category.

8. The method of claim 1, wherein the step (c) comprises:
a step (c-1) of applying transformation parameters extracted from N anchor points to calculate N local transformation matrices;
a step (c-2) of linearly combining the N local transformation matrices to acquire a non-rigid transformation matrix; and
a step (c-3) of applying the non-rigid transformation matrix to the 3D data subsequent to processing to acquire transformed 3D data.

9. A 3D data augmentation apparatus, the apparatus comprising:
one or more processors;
a network interface;
a memory that loads a computer program executed by the processor; and
a storage that stores large-capacity network data and the computer program,
wherein the computer program executes, by the one or more processors,
a first operation of receiving original 3D data and anchor point number information, and acquiring a number of sampled anchor points corresponding to 3D data subsequent to processing and the anchor point number information based on the original 3D data and anchor point number information;
a second operation of receiving at least one transformation parameter and transformation parameter category, and acquiring sample transformation parameter values sampled from the transformation parameter and transformation parameter category; and
a third operation of calculating a non-rigid transformation matrix based on the 3D data subsequent to processing, sampled anchor points, and sample transformation parameter values, and acquiring 3D data transformed by using the non-rigid transformation matrix.

10. A computer program stored on a computer-readable medium, the computer program configured to execute:
in connection with a computing apparatus,
(a) a data processing step of receiving original 3D data and anchor point number information, and acquiring a number of sampled and the anchor point number information based on the original 3D data and anchor point number information;
(b) a transformation parameter sampling step of receiving at least one transformation parameter and transformation parameter category, and acquiring sample transformation parameter values sampled from the transformation parameter and transformation parameter category; and
(c) a data augmentation step of calculating a non-rigid transformation matrix based on the 3D data subsequent to processing, sampled anchor points, and sample transformation parameter values, and acquiring 3D data transformed by using the non-rigid transformation matrix.
